(19) United States
(12) Patent Application Publication
(10) Pub. No.: US 2020/0378570 A1
(43) Pub. Date: Dec. 3, 2020

(54) Remote control illuminating device for mounting alongside a driveway and allowing the driver to be remotely and wirelessly illumiated during a darkened environment

(71) Applicant: Arthur A. Baltes, North Point, FL (US)

(72) Inventor: Arthur A. Baltes, North Point, FL (US)

(21) Appl. No.: 16/501,707

(22) Filed: May 28, 2019

(51) Int. Cl. F21S 9/03; H05B 37/02; F21V 23/04; F21V 29/89; H02J 7/35; H02J 7/00

(52) U.S. Cl. CPC F21S 9/035; H05B 37/0272; F21V 23/0435; F21Y 2103/10; H02J 7/355; H02J 7/0047; H02J 7/0029; F21V 29/89

(57) ABSTRACT

A remote controlled illuminating device of the embodiments of the present invention mounts alongside a driveway, on a post, a mailbox, or the like, and allows the driveway to be remotely and wirelessly illuminated during a darkened environment. The remote controlled illuminating device includes a transmitter, a receiver, a controller, a power source, and a light source. The transmitter selectively transmits a wireless signal. The receiver is in electrical communication with the light source and the controller, and receives the wireless signal. The controller is in electrical communication with the receiver and the power source. The light source is in electrical communication with the receiver and mounts alongside the driveway to illuminate when the transmitter is activated thereby allowing the driveway to be remotely and wirelessly illuminated during the darkened environment.

### BACKGROUND OF THE INVENTION

### Field of the Invention

The embodiments of the present invention relate to a remote controlled illuminating device, and more particularly, the embodiments of the present invention relate to a remote controlled illuminating device for mounting alongside a driveway and allowing the driveway to be remotely and wirelessly illuminated during a darkened environment.

### Description of the Prior Art

Numerous innovations for light-related devices have been provided in the prior art, which will be described, infra, in chronological order to show advancement in the art, and which are incorporated herein in their entirety by reference thereto. Even though these innovations may be suitable for the specific individual purposes to which they address, however, they differ from the embodiments of the present invention. For example:

### U.S. Pat. No. 4,843,337 to Conn, Jr. et al.

U.S. Pat. No. 4,843,337—issued to Conn, Jr. et al. on Jun. 27, 1989 in U.S. Class 340 and subclass 906—teaches a driveway safety light system including a transmitter within a motor vehicle to activate a lamp connected to a receiver at a corner on an end of a driveway so as to indicate to anyone driving down a road that the motor vehicle is about to exit from the driveway.

### Great Britain Patent Application Publication Number GB2317984A to Sanders

Great Britain Patent Application Publication Number GB2317984A—published to Sanders on Apr. 8, 1998 in International Class G08B7 and subclass 06—teaches a system including a housing, the front of which includes the house number. The housing contains a lamp, a light sensor, and electronic control circuitry. The light sensor senses the onset of dusk and causes the circuitry to energize the lamp—battery or mains powered. The system also includes a manually operable switch remote from the housing. The switch is operable by a person in the house to send a signal—via a cable or wirelessly—to the circuitry, which causes the lamp to flash. The housing may also contain an audible alarm, e.g., a voice alarm that is also energized by operation of the switch. A smoke or other hazard detector in the house may also cause the lamp to flash and the alarm to sound. An automatic telephone dialer may also be provided. Other features that may be provided are solar cells to charge batteries in the housing, a PIR sensor to cause the lamp to come on when a person approaches, and a video camera contained within the housing.

### U.S. Pat. No. 6,243,026 to Jones et al.

U.S. Pat. No. 6,243,026—issued to Jones et al. on Jun. 5, 2001 in U.S. Class 340 and subclass 906—teaches that for qualification for traffic preemption an area is defined and if the vehicle is in the area it can obtain preemption. The vehicle's position is determined, in one embodiment, by use of differential GPS.

### United States Patent Application Publication Number 2003/0196358 to Fratzke

United States Patent Application Publication Number 2003/0196358—published to Fratzke on Oct. 23, 2003 in U.S. Class 40 and subclass 597—teaches a vendor, such as, a pizza parlor that promotes its products and improves its service by providing to customers, free of charge, distinctive beacons that can be placed in the window of a home to attract a delivery person. The vendor induces customers to use the beacon by offering discounts and faster delivery service, and benefits from having its advertising prominently displayed in homes.

### U.S. Pat. No. 7,382,252 to Brannon

U.S. Pat. No. 7,382,252—issued to Brannon on Jun. 3, 2008 in U.S. Class 340 and subclass 569—teaches an emergency signal apparatus for alerting police, medical service, neighbors, and people passing by to emergency situations that may arise in, or at, a residence. The apparatus is designed for mounting on an upright post or column such as is commonly used for supporting rural mailboxes, and includes a flashing strobe light and a siren that can be activated by operation of a manual switch in the residence or by operating a remote switch by a radio frequency emitter. The signal apparatus, preferably, includes illuminated house numbers, chimes within the residence, and automatic dialing of the 911 emergency telephone number with a prerecorded message giving name, telephone number, and address.

### United States Patent Application Publication Number 2008/0137342 to Portor

United States Patent Application Publication Number 2008/0137342—published to Portor on Jun. 12, 2008 in U.S. Class 362 and subclass 295—teaches a light or beacon useful for indicating location of a residence or vehicle, such as, car, boat, trailer, or the like. The device is easily mountable, operable manually or remotely, and is useful for indicating position of a residence, business, or vehicle, or the like in a remote or crowded location for simple identification of the house or vehicle from a somewhat remote position, or for delivery of emergency services, and whereby additional information may be simply and effectively communicated for the delivery or emergency or other needs.

### United States Patent Application Publication Number 2010/0265089 to Gregory

United States Patent Application Publication Number 2010/0265089—published to Gregory on Oct. 21, 2010 in U.S. Class 340 and subclass 815.74—teaches a light system for identifying a target location for emergency vehicles, which includes an outdoor light fixture and bulb, and an activation mechanism for selecting and changing between a “constant on” mode, a “constant off” mode, and a “blinking” mode. The system may use a dual-use smart bulb that functions with standard hardware at the location for constant on and constant off modes, but is activated to emergency blinking mode by another device. The lighting system may be incorporated into, or activated by, a security or telephone system for alerting a homeowner or security company when an emergency is indicated at the location.

### United States Patent Application Publication Number 2011/0234396 to Olenick et al.

United States Patent Application Publication Number 2011/0234396—published to Olenick et al. on Sep. 29, 2011 in U.S. Class 340 and subclass 539.13—teaches devices, systems, and methods for locating remote objects and notifying animals that alarms are active, which includes detecting an alarm signal with an alarm sensor and a processor in communication with the alarm sensor and transmitting a locator signal and/or an audio signal having a frequency greater than 20 kHz in response to the detection of the alarm signal.

### United States Patent Application Publication Number 2012/0075872 to Byrne

United States Patent Application Publication Number 2012/0075872—published to Byrne on Mar. 29, 2012 in U.S. Class 362 and subclass 362—teaches an emergency response locator beacon including a first enclosure to house a plurality of electrical circuitry components, a strobe light protruding through a front surface of the first enclosure in electrical communication with the plurality of electrical components, a first apparatus connected to an activation switch in electrical communication with the plurality of electrical components, and a second apparatus to removably attach the first enclosure and the carrier when coupled to a desired support structure.

### United States Patent Application Publication Number 2012/0188075 to Klusmeier II

United States Patent Application Publication Number 2012/0188075—published to Klusmeier II on Jul. 26, 2012 in U.S. Class 340 and subclass 539.14—teaches a remotely activated exterior intermittent alert lighting system that has a case upon a base and receives power from utility service. Upon the case, a light assembly receives power from internal wiring controlled by a processor receptive to short range radio. The processor receives ON and OFF signals through an antenna that receives a signal from a nearby radio transmitter. Upon detecting an ON signal, the processor closes circuits to deliver power to a lighting assembly. The lighting assembly then flashes its elements by the processor or a lighting assembly component. Upon detecting an OFF signal, the processor deactivates the lighting assembly. The lighting assembly typically operates upon direct current provided from a transformer connected to the utility service. Alternatively, the system operates upon battery power.

### Great Britain Patent Number GB2526572A to Bullock

Great Britain Patent Number GB2526572A—published to Bullock on Dec. 2, 2015 in International Class G08B5 and subclass 38—teaches a beacon, preferably, including a 360° bright green LED light cluster that flashes to provide a visual indication of the location of the property. The beacon is attachable to a building, e.g., house exterior, via a mounting bracket. The product aids emergency response personnel when locating the relevant property where assistance is required. The beacon features a base unit containing batteries and a receiver and may be activated by a radio frequency remote. Alternatively, the unit can also contain a mobile phone SIM card receiver for activation by an emergency call center and/or a transmitter allowing a receiver in an emergency vehicle to identify the beacons approximate distance and direction. Above the light cluster is a solar panel to recharge batteries. Additionally, the item may be used with extension arms to ensure the beacon is visible on the house.

It is, thus, apparent that numerous innovations for light-related devices have been provided in the prior art that are adapted to be used. Furthermore, even though these innovations may be suitable for the specific individual purposes to which they address, however, they would not be suitable for the purposes of the embodiments of the present invention as heretofore described.

### SUMMARY OF THE INVENTION

Thus, an object of the embodiments of the present invention is to provide a remote controlled illuminating device for mounting alongside a driveway and allowing the driveway to be remotely and wirelessly illuminated during a darkened environment, which avoids the disadvantages of the prior art.

Briefly stated, another object of the embodiments of the present invention is to provide a remote controlled illuminating device of the embodiments of the present invention that mounts alongside a driveway, such as, on a post, a mailbox, or the like, and allows the driveway to be remotely and wirelessly illuminated during a darkened environment. The remote controlled illuminating device includes a transmitter, an receiver, a controller, a power source, and a light source. The transmitter selectively transmits a wireless signal. The receiver is in electrical communication with the light source and the controller, and receives the wireless signal. The controller is in electrical communication with the receiver and the power source. The light source is in electrical communication with the receiver and mounts alongside the driveway to illuminate when the transmitter is activated thereby allowing the driveway to be remotely and wirelessly illuminated during the darkened environment.

The novel features considered characteristic of the embodiments of the present invention are set forth in the appended claims. The embodiments of the present invention themselves, however, both as to their construction and to their method of operation, together with additional objects and advantages thereof, will be best understood from the following description of the specific embodiments when read and understood in connection with the accompanying figures of the drawing.

### BRIEF DESCRIPTION OF THE FIGURES OF THE DRAWING

The figures of the drawing are briefly described as follows:

FIG. 1 is a diagrammatic perspective view of the remote controlled illuminating device of the embodiments of the present invention mounted alongside a driveway and allowing the driveway to be remotely and wirelessly illuminated during a darkened environment;

FIG. 2 is an exploded diagrammatic perspective view of the remote controlled illuminating device of the embodiments of the present invention shown in FIG. 1; and

FIG. 3 is a diagrammatic schematic view of the remote controlled illuminating device of the embodiments of the present invention shown in FIG. 1.

### LIST OF REFERENCE NUMERALS UTILIZED IN THE FIGURES OF THE DRAWING

### Introductory

10 remote controlled illuminating device of embodiments of present invention for mounting alongside driveway 12, on post 14, mailbox 16, or like, and allowing driveway 12 to be remotely and wirelessly illuminated during darkened environment.
12 driveway
14 post
16 mailbox

### Overall Configuration of Remote Controlled Illuminating Device 10

18 transmitter
20 receiver
22 controller
24 power source
26 light source for mounting alongside driveway 12 to illuminate when transmitter 18 is activated thereby allowing driveway 12 to be remotely and wirelessly illuminated during darkened environment
28 wireless signal

### Specific Configuration of Receiver 20 and Controller 22

30 antenna of receiver 20
32 charging module of controller 22
34 box
36 pair of removable covers of box 34.

### Specific Configuration of Power Source 24

38 solar panel of power source 24
40 battery of power source 24
42 rechargeable Li-ion battery of battery 40 of power source 24

### Specific Configuration of Box 34

46 endless wall of box 34
48 pair of opposing open faces of box 34

### Specific Configuration of Light Source 26

50 linear LED array of light source 26

### DETAILED DESCRIPTION OF THE PREFERRED EMBODIMENTS

### Introductory

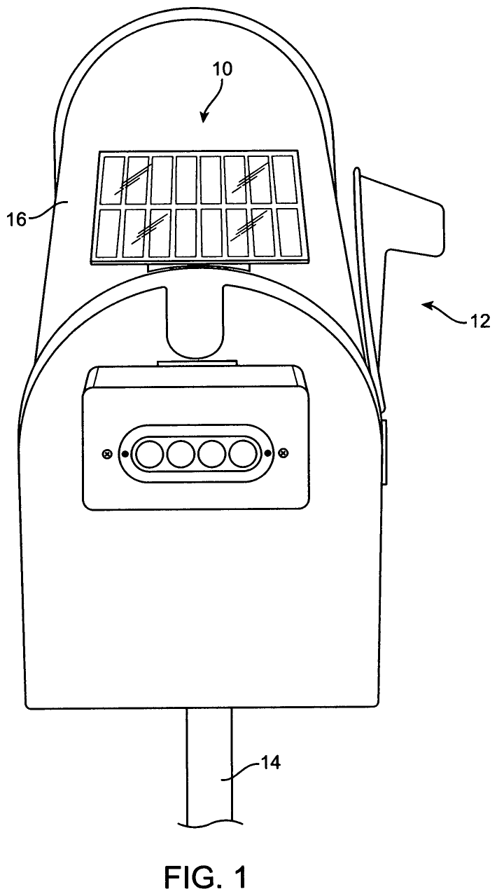

Referring now to the figures, in which like numerals indicate like parts, and particularly to FIG. 1, the remote controlled illuminating device of the embodiments of the present invention is shown generally at 10 for mounting alongside a driveway 12, on a post 14, a mailbox 16, or the like, and allowing the driveway 12 to be remotely and wirelessly illuminated during a darkened environment.

### Overall Configuration of the Remote Controlled Illuminating Device 10

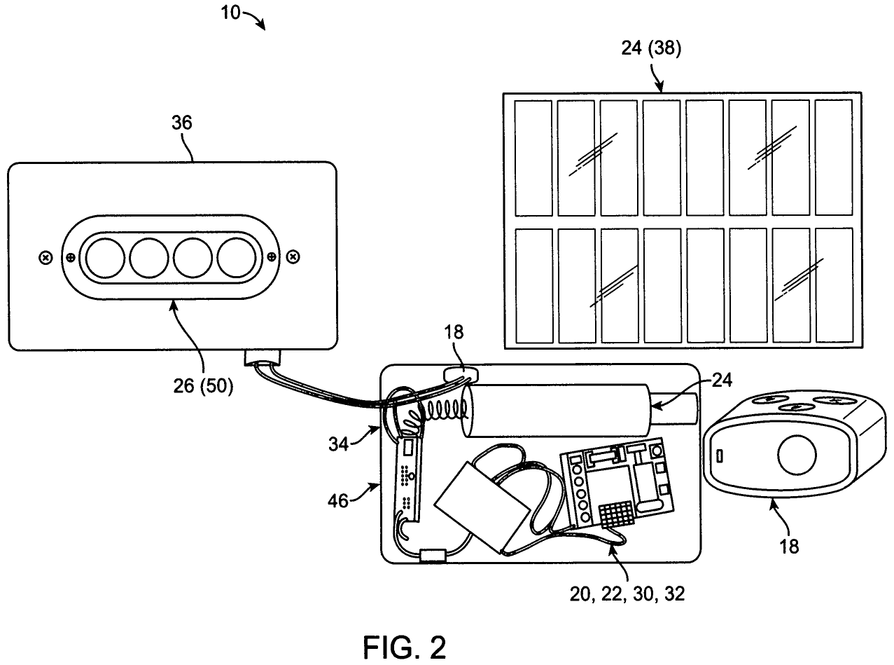

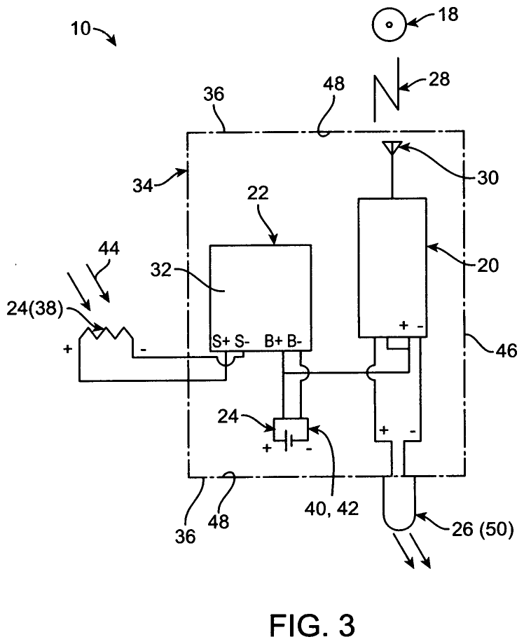

The overall configuration of the remote controlled illuminating device 10 can best be seen in FIGS. 2 and 3, and as such, will be discussed with reference thereto.

The remote controlled illuminating device 10 comprises a transmitter 18, a receiver 20, a controller 22, a power source 24, and a light source 26. The transmitter 18 selectively transmits a wireless signal 28. The receiver 20 is in electrical communication with the light source 26 and the controller 22, and receives the wireless signal 28. The controller 22 is in electrical communication with the receiver 20 and the power source 24. The power source 24 is in electrical communication with the controller 22. The light source 26 is in electrical communication with the receiver 20 and is for mounting alongside the driveway 12 to illuminate when the transmitter 18 is activated thereby allowing the driveway 12 to be remotely and wirelessly illuminated during the darkened environment.

### Specific Configuration of the Transmitter 18

The transmitter 18 has a working voltage of DC 3.5V-DC 12V, and as such, has a wide range of working voltages of DC 3.7V, DC 4.5V, DC 5V, DC 6V, DC 9V, and DC 12 V.

The transmitter 18 has a quiescent current of 5 ma, a relay working current of 20-30 ma, and a size of 25 mm by 11.8 mm.

The transmitter 18 includes three working modes:

1. A momentary working mode;

2. A toggle working mode; and

3. A latched adjustable working mode (default).

### Momentary Working Mode

When using a one channel switch, only a one button remote control for the transmitter 18 is needed. Press the one button for working ON and release the one button for stop OFF.

### Toggle Working Mode

When using a one channel switch, only a one button remote control for the transmitter 18 is needed. Press the one button for one time for working ON and release the one button for stop OFF.

### Latched Adjustable Working Mode

When using a one channel switch, a two button remote control for the transmitter 18 is needed. Press one button for working ON and release the other button for stop OFF. The default of transmitter 18 is set to this mode, but is changeable.

### Specific Configuration of the Receiver 20 and the Controller 22

The receiver 20 is an RF receiver and has an antenna 30, and the controller 22 has a charging module 32.

The receiver 20 with the antenna 30 of the receiver 20 and the controller 22 with the charging module 32 of the controller 22 are contained within a box 34 having a pair of removable covers 36.

### Specific Configuration of the Power Source 24

The power source 24 includes a solar panel 38 and a battery 40. The solar panel 38 of the power source 24 and the battery 40 of the power source 24 are in electrical communication with the controller 22.

The battery 40 of the power source 24 is a rechargeable Li-ion battery 42 that is charged by the solar panel 38 of the power source 24.

The battery 40 of the power source 24 has a nominal voltage of 3.7V, a nominal capacity of 3400 mAh, and discharges from 4.2V to 3.0V at 0.2 C mA.

The battery 40 of the power source 24 has a minimal capacity of 3300 mAh and a maximum charge current of 3400 mA 1C.

The battery 40 of the power source 24 charges with a constant current of 1 C to 4.2V, then charges with a constant voltage of 4.2V until charge current is less than 0.01 C, and has a discharge cut-off voltage of 3.0V that is over-charge detection voltage.

The battery 40 of the power source 24 charges in a range of 0° C.-45° C. at 6520%RH and discharges in a range of −20° C. -60° C. at 6520%RH.

The battery 40 of the power source 24 has a storage environment of −20° C. to 45° C. at 6520%RH and a cell weight of 50 g max, and when stored for long periods of time, i.e., >3 months, the storage condition is <35° C. at 6520%RH and in a range of 3.7V to 3.9V,

### Specific Configuration of the Charging Module 32

The charging module 32 provides linear charging of an adjustable 1 A with a 1.5% charge precision.

The charging module 32 has an input voltage of 4.5V-5-5V and a full charge voltage of 4.2V.

The charging module 32 further has a pair of LEDs. A first LED of the charging module 32 illuminates red during charging and a second LED of the charging module 32 illuminates green when charged.

The charging module 32 still further has an input interface and mini USB and solder plates, and is of a small size of 27 mm×19 mm×5 mm.

The charging module 32 yet further has a work temperature in a range of −10° C. to 85° C. and does not have inversed polarity.

An ampere meter can only be connected to the 5V input end of the charging module 32. When charging, a charging current of 37% of the battery 40 of the power source 24 capacity is optimal. For example, if one charges the battery 40 of the power source 24 of 1000 mAH, then a current of 400 is sufficient.

It is imperative that a proper gauge wire be used for the current being used. Too thin a gauge of wire will burn, while too thick a gauge of wire will cause the circuit to not act correctly. It is further imperative that the connections at the contact proper are steady.

If the input voltage is too high, i.e., 5.2V, the current will be less than 1A as a normal protection function, and there is no reverse polarity so that connecting the battery 40 of the power supply 24 the wrong way will fry the charging module 32.

The current can be altered, i.e., lowered, by changing a resistor to a higher resistor. In this configuration, the charging module 32 shifts with the current being 1A. The current can be raised by changing the resistor to a lower resistor. Please see TABLE 1, infra.

The following TABLE 1 gives estimates of resistance versus current.

| Ohms | mA |
|---|---|
| 30K | 50 |
| 20K | 70 |
| 10K | 130 |
| 5K | 250 |
| 4K | 300 |
| 3K | 400 |
| 2K | 580 |
| 1.66K | 690 |
| 1.5K | 780 |
| 1.33K | 900 |
| 1.2K | 1000 |

### Specific Configuration of the Box 34 and the Pair of Removable Covers 36 of the Box 34

The box 34 is generally rectangular-shaped and is an endless wall 46, thereby having a pair of opposing open faces 48 selectively closed by the pair of removable covers 36 of the box 34, respectively, by the use of buckles, eliminating a need for boring screw holes and using screws.

The endless wall 46 of the box 34 and the pair of removable covers 36 of the box 34 are made of ABS plastic.

The box 34 has outer dimensions of approximately 3.94″×2.36″×0.98″ (100 mm×60 mm×25 mm), inner dimensions of approximately 3.8″×2.2″×0.8″ (96 mm×56 mm×21 mm), average wall thickness of 0.08″ (2 mm), and weighs approximately 36 g (0.08 lb).

### Specific Configuration of the Light Source 26

The light source 26 is a linear LED array 50. The linear LED array 50 of the light source 26 is mounted to one of the removable covers 36 of the box 34, and is 3.38″(8.6 cm) long, 1.1″ (2.8 cm) wide, and 0.38″ (1 cm) high, and consists of four LEDs including a pair of red LEDs and a pair of blue LEDs.

The linear LED array 50 of the light source 26 operates at 12V-24V and 12 W (3 W/LED), has PC lenses that are heat resistant, and a base that is made of high quality aluminum alloy, weighs 2.02 oz., and includes a three wire connection having black for negative, red for positive, and yellow for brake light negative to change flash pattern.

The linear LED array 50 of the light source 26 further has low power consumption, is energy saving, has a long lifespan, has a fast on/off response time, has a variety of different flashing patterns with last pattern memory recall, and is waterproof, ultra-slim, super bright, and surface mountable.

### Impressions

It will be understood that each of the elements described above, or two or more together, may also find a useful application in other types of constructions differing from the types described above.

While the embodiments of the present invention have been illustrated and described as embodied in a remote controlled illuminating device for mounting alongside a driveway and allowing the driveway to be remotely and wirelessly illuminated during a darkened environment, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

1-20. (canceled)

22. The method of claim 21, further comprising: the light source is activated by the transmitter, and the user can activate the illumination device prior to a visitor coming to their home, or when driving to their own home in a darkened environment to help identify the exact location of their driveway.

23. The method of claim 21, further comprising: after the light source is illuminated, the light source blinks for easily identifying the direct location for the user.

24. The method of claim 21, further comprising: the light source can be turned off by the transmitter at any time or when the location has been identified.

25. The method of claim 21, further comprising: a user identifying their home/driveway in a darkened environment by viewing the illuminated light source.
